(19) United States
(12) Patent Application Publication
(10) Pub. No.: US 2013/0240172 A1
(43) Pub. Date: Sep. 19, 2013

(54) Hydronic System and Control Method

(71) Applicants: William C. Reilly, Langhorne, PA (US); William J. Reilly, Langhorne, PA (US)

(72) Inventors: William C. Reilly, Langhorne, PA (US); William J. Reilly, Langhorne, PA (US)

(73) Assignee: Victaulic Company, Easton, PA (US)

(21) Appl. No.: 13/418,738

(22) Filed: Mar. 13, 2012

(51) Int. Cl. F28F 27/00; G05D 23/00

(52) U.S. Cl. 165/11.1; 165/288

(57) ABSTRACT

A hydronic system controls the air temperature in a plurality of zones. The system has a plurality of heat exchangers, each one being associated with a respective zone. The mass flow rate of a working fluid through each heat exchanger is controlled to maintain the working fluid temperature drop across the heat exchanger a constant, chosen for efficient operation of the boiler or chiller which transfers heat to or from the working fluid. The flow of air in each zone through each heat exchanger is controlled by the air temperature in the zone. A respective valve associated with each heat exchanger is used to control the mass flow rate of the working fluid through the heat exchanger, and also imposes an upper limit of the mass flow rate established by balancing the hydronic system. The upper limit is controlled by a parameter proportional to mass flow rate.

### FIELD OF THE INVENTION

This invention relates to hydronic systems for environmental control within structures.

### BACKGROUND

Hydronic systems are hydraulically based systems for heating and cooling interior environments, such as office buildings, hospitals, apartment buildings and other edifices where there are many areas, isolated from one another, known as zones, which require individual control of the air temperature in each of the zones. The zones may correspond, for example, to the various rooms in a building.

Hydronic systems may comprise one or more boilers and chillers which are in fluid communication with a plurality of heat exchangers through a piping network. There may be, for example, one heat exchanger in each zone. The piping network carries a working fluid, for example water, between the boilers or the chillers and the heat exchangers in each zone. The working fluid is heated by the boiler or cooled by the chiller and flows to the heat exchangers, where heat is either imparted to or removed from the air in the zone depending on the difference between the actual air temperature and the desired air temperature. The heat exchangers may be, for example, variable air volume boxes which work in conjunction with a thermostat in the zone and the hydronic system controls to heat or cool the zone air as necessary to achieve the desired zone air temperature. Flow of the working fluid through each heat exchanger is controlled by a control valve associated with the heat exchanger which opens and closes to vary the mass flow rate of the working fluid through the heat exchanger in response to the demand for heating or cooling in each zone.

For proper operation of the hydronic system it is necessary to balance the flow of working fluid throughout the system so that all of the heat exchangers in all of the zones always have access to sufficient mass flow volume of the working fluid to achieve and maintain a desired zone air temperature for a particular set of design parameters peculiar to the location of the building and its thermal characteristics. Unless the system flow is balanced, the mass flow rate to each heat exchanger will naturally vary as a function of the head loss to each heat exchanger. The head loss for each heat exchanger will vary depending upon the length of the path from the pump to each heat exchanger, the friction encountered by the flow, and the height of the heat exchanger above the pump. System balancing involves using separate balancing valves positioned in series with the control valves associated with each heat exchanger to limit the flow of working fluid to an allowable maximum which ensures that no heat exchanger will be starved of working fluid. The hydronic system may be balanced, for example, by fully opening all of the control valves, pumping working fluid through the hydronic system to each of the heat exchangers, and setting each of the balancing valves so that the mass flow rate is the same to each heat exchanger in each zone. Using balancing valves to limit the maximum flow through each control valve ensures that each of the heat exchangers will always have a sufficient mass flow rate to achieve and maintain the desired air temperature in its zone regardless of the demand for working fluid in other zones in the hydronic system.

Hydronic systems according to the prior art which use both balancing valves and control valves are costly because they require at least two valves per heat exchanger. It is furthermore a challenge to balance hydronic systems, and they can suffer from inefficient operation depending upon what parameters are used to throttle the control valves. It is clear that advantages may be obtained by more efficient hydronic systems which use fewer valves, and which control the valves with efficient energy usage as a consideration.

### SUMMARY

The invention concerns a hydronic system for controlling the air temperature in a plurality of zones. In one example, the hydronic system comprises a working fluid for effecting heat transfer and a first heat exchanger for imparting or removing heat to or from the working fluid. At least one of a plurality of first temperature measuring devices measures the air temperature in at least one of the zones. At least one of a plurality of second heat exchangers imparts or removes heat to or from air in the at least one zone. The at least one second heat exchanger is in fluid communication with the first heat exchanger. In one example embodiment, the at least one second heat exchanger comprises a valve controlling a mass flow rate of the working fluid through the at least one second heat exchanger. A second temperature measuring device measures a change in temperature of the working fluid across the at least one second heat exchanger. The example hydronic system may further comprise at least one pump in fluid communication with the first heat exchanger and the at least one second heat exchanger for pumping the working fluid therebetween. A controller, in communication with the at least one first temperature measuring device, the second temperature measuring device and the valve associated with the at least one second heat exchanger controls the valve for the at least one second heat exchanger in the at least one zone in response to signals from the first and second temperature measuring devices.

In an example hydronic system the first heat exchanger may comprise a boiler for adding heat to the working fluid, a chiller for removing heat from the working fluid, or a plurality of boilers and chillers.

The example hydronic system may further comprise a fan controlling a mass flow rate of the air through the at least one second heat exchanger, the fan being in communication with the controller, the controller controlling the fan in response to signals from the first temperature measuring device indicative of the air temperature in the at least one zone.

The example hydronic system may further comprise a means for measuring a mass flow rate of the working fluid through the at least one second heat exchanger, the controller being in communication with the means for measuring the mass flow rate and controlling the valve so as to limit the mass flow rate of the working fluid through the at least one second heat exchanger to a maximum value in response to signals from the means for measuring the mass flow rate of the working fluid.

The invention further comprises a method of operating a hydronic system for controlling the air temperature in a plurality of zones. An example method comprises:
moving a working fluid through a plurality of heat exchangers, each heat exchanger being associated with a respective one of the zones;
for each of the zones, moving air from the zone through the heat exchanger associated therewith for transferring heat between the working fluid and the air in the zone;
for each of the heat exchangers, measuring a first temperature of the working fluid before heat is transferred between the working fluid and the air;
for each of the heat exchangers, measuring a second temperature of the working fluid after heat is transferred between the working fluid and the air;
for each of the heat exchangers, adjusting the mass flow rate of the working fluid through the heat exchanger so as to maintain a constant temperature difference between the first and second temperatures of the working fluid;
for each of the zones, measuring the air temperature in the zone; and
for each of the heat exchangers and each of the zones, adjusting the mass flow rate of air from the zone through the heat exchanger associated therewith so as to achieve and maintain a desired air temperature in the zone.

The example method may further comprise:
for each of the heat exchangers, establishing a respective maximum permitted mass flow rate of the working fluid therethrough;
for each of the heat exchangers, measuring the mass flow rate of the working fluid therethrough; and
for each of the heat exchangers, adjusting the mass flow rate of the working fluid therethrough so that it is no greater than the respective maximum permitted mass flow rate.

Establishing the respective maximum permitted mass flow rate of the working fluid through each of the heat exchangers may comprise balancing a mass flow of the working fluid through the hydronic system so that the mass flow rate of the working fluid through each of the heat exchangers is sufficient to meet a maximum required heat load at all times during operation of the hydronic system. Heat load is the required heating or cooling of a heat exchanger to maintain a desired comfort level in a zone.

In another example of the method, the mass flow rate of the working fluid through each of the heat exchangers is adjusted so as to maintain a constant temperature difference of about 20° F. between the first and second temperatures of the working fluid.

In another example of the method, the mass flow rate of the working fluid through each of the heat exchangers is adjusted so as to maintain a constant temperature difference of about 40° F. between the first and second temperatures of the working fluid.

In another example of the method the mass flow rate of the working fluid through each of the heat exchangers is adjusted so as to maintain a constant temperature difference from about 20° F. to about 60° F. between the first and second temperatures of the working fluid.

In another example of the method, the mass flow rate of the working fluid through each of the heat exchangers is adjusted so as to maintain a constant temperature difference of about 10° F. between the first and second temperatures of the working fluid.

In another example of the method the mass flow rate of the working fluid through each of the heat exchangers is adjusted so as to maintain a constant temperature difference from about 10° F. to about 30° F. between the first and second temperatures of the working fluid.

### BRIEF DESCRIPTION OF THE DRAWINGS

FIGS. 1 and 1A are schematic illustrations of example hydronic systems according to the invention;

FIGS. 2, 3, 3A and 4 are schematic illustrations of alternate embodiments of components useable in the hydronic system according to the invention; and

FIG. 5 is a flow chart illustrating an example method of operating a hydronic system according to the invention.

### DETAILED DESCRIPTION

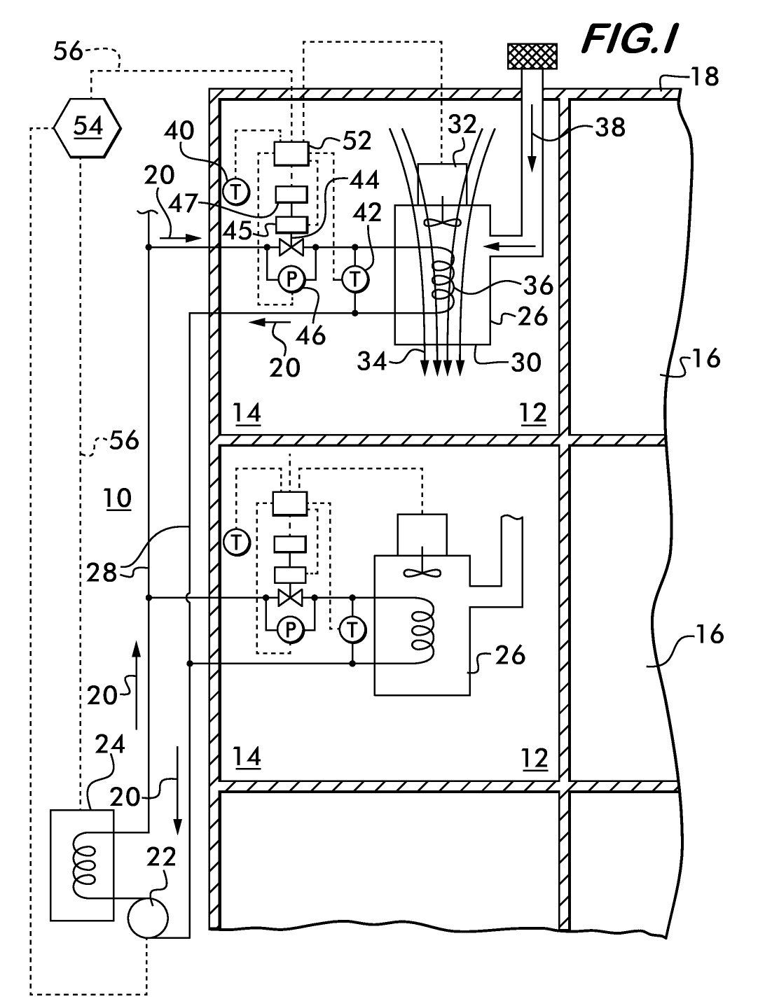

FIG. 1 shows, in schematic form, an example hydronic system 10 according to the invention. Hydronic system 10 controls the air temperature in one or more zones 12, for example, in rooms 14 on different floors 16 of an office building 18.

Hydronic system 10 comprises a working fluid 20, in this example, water, which is circulated by a pump 22 through a first heat exchanger 24 and one or more second heat exchangers 26, the heat exchangers and pump being in fluid communication through a piping network 28. The first heat exchanger 24 may comprise a boiler for imparting heat to the working fluid 20 to heat the zones 12, or the first heat exchanger may be a chiller to remove heat from the working fluid when the zones are to be cooled. Hydronic systems 10 may have multiple chillers and boilers as required to heat and cool the zones, the first heat exchanger 24 generally representing these devices for imparting heat to or removing heat from the working fluid as needed for a particular design.

Each second heat exchanger 26 is associated with a particular zone 12 and imparts heat to or removes heat from the air within its associated zone for controlling the zone air temperature. FIG. 1 shows a plurality of zones 12, each with an associated heat exchanger 26. The hydronic system 10 is further described below with respect to one zone, it being understood that other zones using the system according to the invention will be identical.

Heat exchanger 26 may be, for example, a radiator, or a variable air volume box (VAV box) 30. VAV box 30 comprises a fan 32 which draws zone air 34 from the associated zone 12 and passes it over coils 36 or other heat transfer surfaces through which the working fluid 20 is circulated. The zone air 34 may be heated or cooled as desired by conductive heat transfer between the zone air 34 and the coils 36, the air, thus cooled or heated, being returned to the zone 12. Fresh air 38 from outside of the zone 12, usually ambient air from outside of the building 18, is also drawn in to the VAV box and injected into the zone 12 with the zone air 34 that is recirculated within the zone. The volume of fresh air 38 added to a zone 12 is typically based upon occupancy type and the number of occupants and can range from 5-60 air exchanges per hour as recommended by the American Society of Heating, Refrigeration and Air Conditioning.

A first temperature measuring device 40 is associated with each zone 12. Temperature measuring device 40 measures the air temperature within zone 12 and may be, for example, a thermostat, which generates a signal, such as an electrical voltage or current, indicative of the air temperature, or the difference between the air temperature and a desired air temperature in the zone. A second temperature measuring device 42 measures the temperature change of the working fluid across the heat exchanger 26 associated with the zone 12. The temperature change “across the heat exchanger” means the difference in temperature between the working fluid 20 as it enters the heat exchanger (i.e., before heat is transferred between the working fluid and the zone air 34) and as it leaves the heat exchanger (i.e. after heat is transferred between the working fluid and the zone air), and is thus indicative of the heat transfer between the working fluid 20 and the zone air 34 and the fresh air 38 passing through the heat exchanger 26 in the zone 12.

A valve 44, associated with zone 12, is positioned in the piping network 28 between the heat exchanger 24 and the heat exchanger 26. Opening and closing of valve 44 is remotely controllable, and the valve is adjustable to act as a throttle to control the mass flow rate of the working fluid 20 to the associated heat exchanger 26. Remote actuation of the valve 44 may be effected, for example, by an actuator 45, such as a stepper motor mounted on the valve, and knowledge of the degree to which the valve is open or closed may be obtained using a positional encoder 47, such as a rotary encoder, which generates a signal, for example, an electrical voltage or current, indicative of the position of the valve throttling member at or between its open and closed positions.

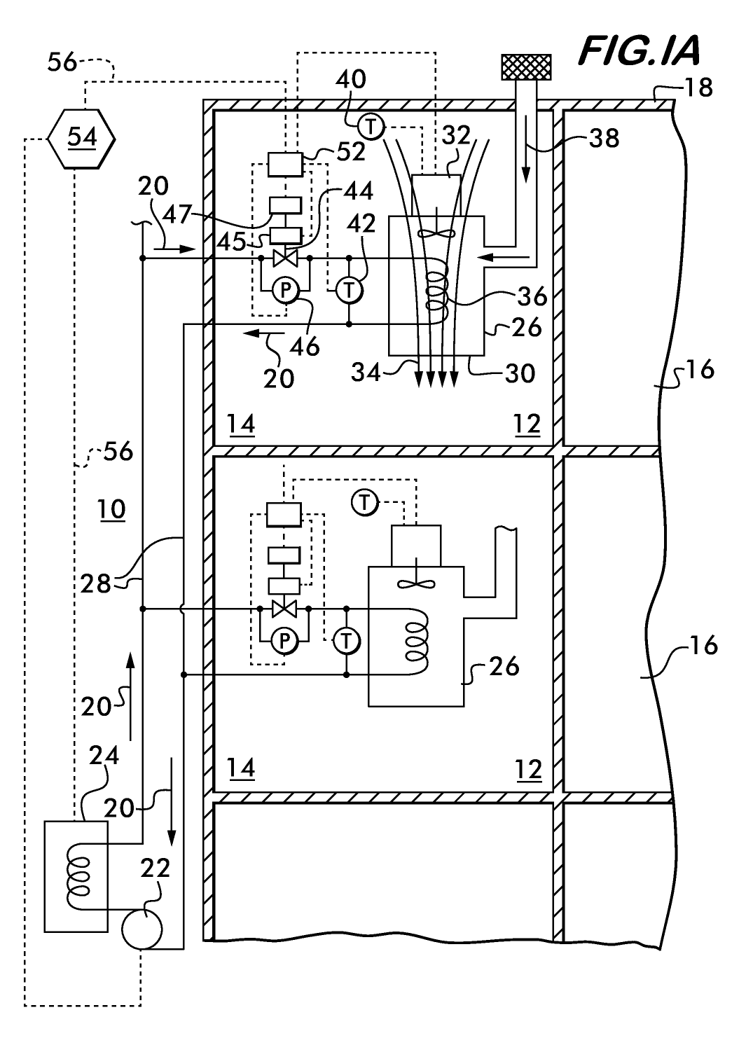

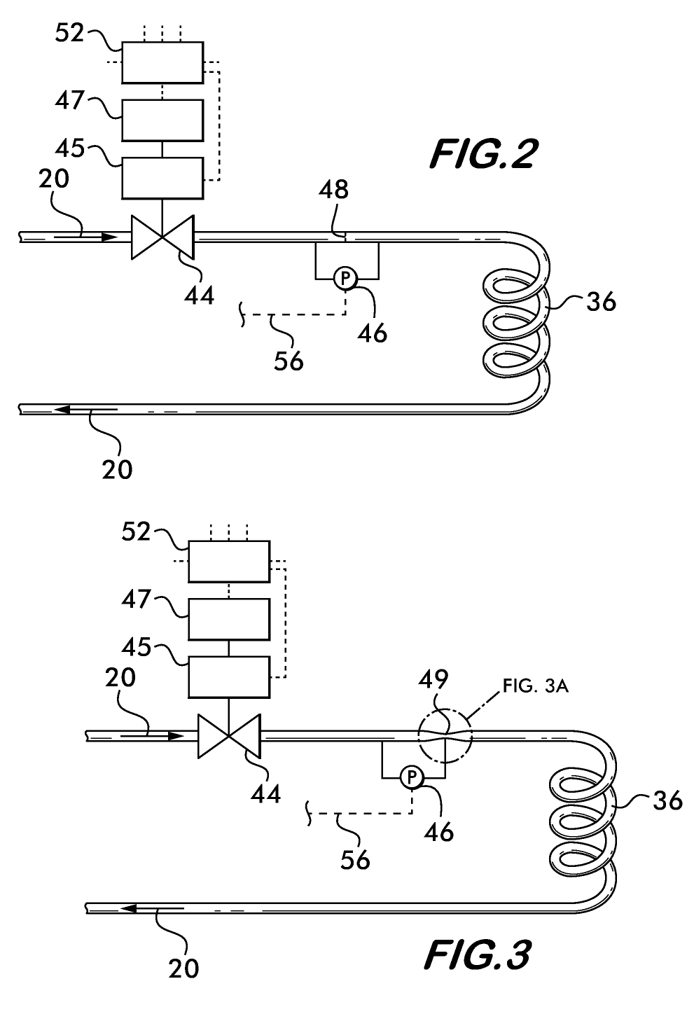

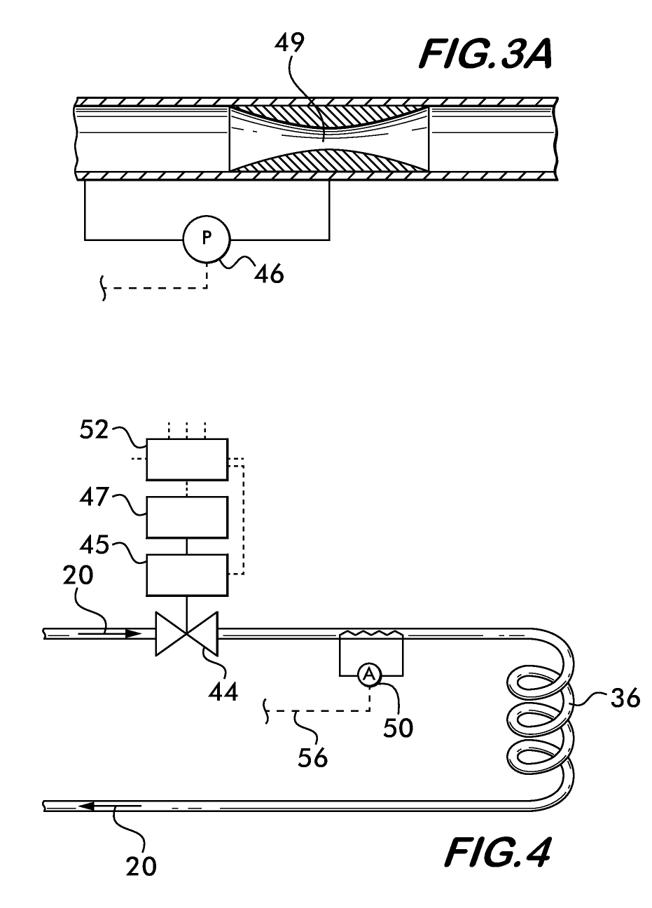

Valve 44 may also act to limit the mass flow rate through the heat exchanger to a maximum mass flow rate, determined, for example, by the requirements for balancing the working fluid flow to and from all of the heat exchangers 26 throughout the hydronic system 10. The maximum permitted flow rate may also be limited to avoid excess noise and wear caused by high mass flow rates. One method of limiting the maximum mass flow rate through the heat exchanger 26 involves measuring the change in pressure, or pressure drop, of the working fluid 20 across the valve 44 associated with the heat exchanger. The mass flow rate of fluid through the valve (and hence through the heat exchanger) is proportional to this pressure drop. To this end, a pressure measuring device 46 is used to measure the working fluid pressure as it enters and leaves the valve 44. The pressure measuring device 46 may be, for example a piezo-electric based device, which generates a signal, for example, an electrical voltage or current, indicative of the difference between the working fluid pressure as it enters and leaves the valve 44. Knowing this pressure difference, the mass flow rate though the valve can be calculated using the formula M=Cᵥ(Pᵢₙ−Pₒᵤₜ)^{1/2}, where M is the mass flow rate, Pᵢₙ is the working fluid pressure upon entering the valve, Pₒᵤₜ is the working fluid pressure upon exiting the valve and Cᵥ represents the particular flow characteristics of the valve, obtained from empirical measurements. Other devices may be used to determine the mass flow rate of the working fluid through the heat exchanger 26. For example, as shown in FIG. 2, the pressure measuring device 46 may be used to measure the pressure difference across a fixed orifice 48. FIG. 3 illustrates the use of the pressure measuring device with venturi 49 positioned within the piping network 28 proximate to the heat exchanger 26, the venturi being a well established device for accurately measuring flow rate. Alternately, mass flow rate may be measured using a hot wire anemometer 50 as shown in FIG. 4, the anemometer generating a signal, for example an electrical voltage or current, indicative of the mass flow rate. Other mass flow measurement devices, such as sonic-based devices, magnetic-based devices as well as spinning vane type devices may also be used.

A shown in FIG. 1, each valve 44 has associated with it a zone controller 52, such as a microprocessor or a programmable logic controller, which controls the operation of the valve 44 and the heat exchanger 26 as described below. Zone controllers 52 can also be programmed to store the valve characteristics Cᵥ (or the venturi or hot wire anemometer flow characteristics) and the maximum permitted flow rate for the valve. These parameters are useful both to balance the flow of working fluid to all valves 44 throughout the hydronic system 10 as well as for control of each valve individually during operation of the system.

In one embodiment, shown in FIG. 1, the zone controller 52 is in communication with fan 32 of the VAV box 30 (when present), the temperature measuring device 40 (measuring the temperature of the zone air 34), the temperature measuring device 42 (measuring the temperature change of the working fluid across the heat exchanger 26), the pressure measuring device 46 (measuring the mass flow rate of the working fluid 20 through the heat exchanger 26), the valve actuator 45 and the positional encoder 47 of the valve 44. The controllers 52 of the various zones are also in communication with a building controller 54 that controls the heat exchanger 24 and the pump 22 in response to signals from the various zone controllers 52. Building controller 54 may also be a microprocessor or programmable logic controller. Communication between the various components and their respective controllers 52 as well as between the zone controllers 52 and building controller 54 is effected over communication lines 56, which may represent, for example, hardwired electrical lines, or wireless links. Using resident software and the communication lines 56, controller 52 controls operation of fan 32 and valve 44 through its associated actuator 45. Controller 52 furthermore receives signals from the positional encoder 47 associated with valve 44, the pressure measuring device 46 (or the hot wire anemometer 50), the temperature measuring device 40 and the temperature measuring device 42 to effect efficient climate control of a zone 12 within the building 18 as described below. In another system embodiment, shown in FIG. 1A, the temperature measuring device 40, which measures the temperature of the zone air 34, is in direct communication with the fan 32 of the VAV box 30, thereby affording a different control relationship between the zone controller 52 and the VAV box as described below. The other communication links in this embodiment remain the same as described above with reference to FIG. 1.

### Method of Balancing the Hydronic System

Hydronic systems must be “balanced” to ensure effective operation. “Balancing” as used herein refers to adjusting the mass flow rate of the working fluid throughout the hydronic system so that there is sufficient flow available to all zones which will meet the required heat load of each zone when all zones demand maximum mass flow for heating or cooling of the zones. “Heat load” is the amount of heating or cooling required to maintain the desired comfort level in a zone. Balancing is necessary because, if the flow of working fluid is otherwise uncontrolled, the heat exchangers 26 in zones 12 remote from the pump 22 will naturally receive a lower mass flow rate than the heat exchangers in zones proximate to the pump. This unequal flow rate results from head losses due to friction and potential energy differences among zones at different heights and at different distances from the pump.

The example hydronic system 10 as described above may be used to efficiently balance itself without the need for additional balancing valves normally associated with hydronic systems. An example balancing method comprises using the controller 54 to operate pump 22 and heat exchanger 24 to pump the working fluid 20 to the heat exchangers 26 in each zone 12 in the building 18. Controllers 52 in each zone 12 then use signals from their respective pressure measuring devices 46 to measure the instantaneous mass flow rate through their respective valves 44 to their associated heat exchangers 26. Knowing these flow rates, the controllers 52 send control signals to the actuators of their respective valves 44, opening or closing the valve to the degree required to achieve the flow through every valve 44 to meet the heat load for every zone 12 in the system 10. This is an iterative process which is controlled by the resident software of the controllers 52 and the process converges on a set of valve settings which determine, for each valve 44, the maximum permitted mass flow rate through that valve. The maximum permitted mass flow rate for each valve 44 is recorded in the zone controller 52 associated with each valve 44, and that information is used during system operation to limit the maximum flow rate of working fluid through a particular valve. The information may be recorded, for example, as a pressure difference across the valve or an orifice or venturi associated with the valve, a reading from the hot wire anemometer associated with a valve, or a particular position of the valve throwing member as reported by the positional encoder 47 associated with the valve 44. The hydronic system 10 thus uses the valves 44 for establishing and maintaining hydronic system balance and obviates the need for separate balancing valves which would otherwise be positioned in series with each valve 44 and set so as to permit a mass flow rate no greater than the maximum permitted for a particular heat exchanger 26 and thereby override the valve 44 if it calls for a greater mass flow than is permitted during system operation.

### Method of System Operation

In an example method of operating hydronic system 10, the controller 54 commands pump 22 to move the working fluid 20 through the heat exchanger 24, where heat is added or removed from the working fluid depending upon whether the zones 12 are to be heated or cooled. This example method describes system operation for heating the zones with reference to the system shown in FIG. 1, the method for cooling being similar. The description is further directed to one zone, it being understood that similar operational actions are being carried out contemporaneously for many or all zones associated with the hydronic system 10.

Temperature measuring device 40 (a thermostat) measures the temperature of the zone air 34 in a particular zone 12 and compares it to a desired temperature for that zone. If the measured temperature is below the desired temperature, measuring device 40 signals zone controller 52, transmitting information that the actual temperature of air 34 in zone 12 is below the desired temperature. In response to this signal, the zone controller 52 signals actuator 45 which opens valve 44. Valve 44, being in fluid communication with both heat exchanger 24 and the heat exchanger 26 associated with the zone 12, permits working fluid 20 to flow to the heat exchanger 26. When the heat exchanger 26 is a VAV box 30 (as opposed to a radiator), zone controller 52 also activates fan 32 to force zone air 34 though the heat exchanger 26 where heat is transferred from the working fluid 20 to the air 34 through conduction between the air and the coils 36 before it is discharged back into the zone 12. Fresh or “make-up” air 38 is also drawn from the ambient, forced through the heat exchanger 26 and into the zone 12. The zone controller 52 receives signals from the temperature measuring device 42, which measures the temperature difference of the working fluid 20 across the heat exchanger 26, i.e. the temperature difference between the working fluid 20 before heat is transferred between it and the zone air 34, and after heat is transferred between the working fluid 20 and the zone air 34. The zone controller 52 uses this information to adjust the mass flow rate of the working fluid 20 through the heat exchanger 26 by adjusting the valve 44 so as to maintain the temperature difference of the working fluid 20 across the heat exchanger constant. Maintaining this constant temperature difference allows the heat exchanger 24, which supplies heat to the working fluid 20, to operate more efficiently than if other parameters were used as a criterion for controlling the mass flow rate. When the system is in the heating mode of operation, temperature differences from about 20° F. to about 60° F. are considered practical, with a constant temperature difference of about 20° F. or about 40° F. being advantageous for the efficient operation of modern boilers used in large scale climate control systems. When the system is in the cooling mode of operation, temperature differences from about 10° F. to about 30° F. are considered practical, with a constant temperature difference of about 10° F. or about 20° F. being advantageous for the efficient operation of modern chillers used in large scale climate control systems. Thus the zone controller 52 adjusts the valve 44 by opening and closing its throttling member as required to maintain the desired constant temperature difference across the heat exchanger 26. The mass flow rate of the working fluid 20 through the heat exchanger 26 will fluctuate in response to the heat transfer from the working fluid to the zone air 34 as the zone air passes through the heat exchanger 26 and is recirculated through the zone 12. The zone controller 52 receives signals from the temperature measuring device 40 which it uses to control the mass flow rate of zone air 34 through the heat exchanger 26 by controlling the operation of fan 32, thereby controlling the air temperature within the zone 12. Depending upon the nature of the control regime, the fan 32 may run at a constant speed, shutting off when the desired zone temperature is reached or exceeded by a set amount, or it may run at varying speeds, decreasing the mass flow rate of zone air 34 through the heat exchanger 26 as the desired zone temperature is approached.

It is conceivable, however, that the zone controller 52, using only the change in temperature of the working fluid across the heat exchanger 26 to directly control the valve 44 may, under some circumstances, command its valve 44 to open to a degree at which the mass flow rate of the working fluid 20 through the valve will exceed the maximum permitted mass flow rate established during balancing of the system 10. This cannot be permitted, because it may result in some heat exchangers being starved for working fluid and therefore unable to control the air temperature in their associated zone and not meet their heat load as various heat exchangers compete for the working fluid and the system flow regime becomes out of balance. To avoid this situation, the controller 52 uses signals from the pressure measuring device 46 to adjust the valve 44 to limit the degree to which it may open so as not to exceed the maximum permitted mass flow rate established for the valve 44 during balancing of the system. In another embodiment, the controller 52 may use the output from the hot wire anemometer 50 associated with its valve 44, which also provides signals indicative of the instantaneous mass flow rate of the working fluid through the valve.

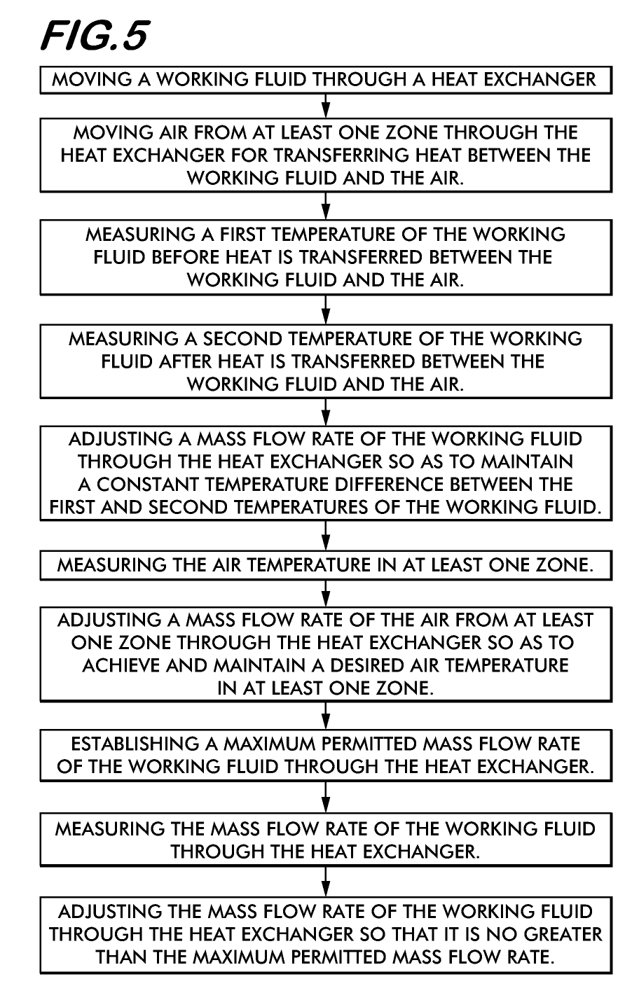

FIG. 5 is a flow chart which illustrates an example method for controlling the hydronic system disclosed herein. As noted, the method comprises:
moving a working fluid through a heat exchanger;
moving air from at least one zone through the heat exchanger for transferring heat between the working fluid and the air;
measuring a first temperature of the working fluid before heat is transferred between the working fluid and the air;
measuring a second temperature of the working fluid after heat is transferred between the working fluid and the air;
adjusting a mass flow rate of the working fluid through the heat exchanger so as to maintain a constant temperature difference between the first and second temperatures of the working fluid;
measuring the air temperature in the at least one zone; and
adjusting the mass flow rate of the air from the at least one zone through the heat exchanger so as to achieve and maintain a desired air temperature in the at least one zone.

The method may also include:
establishing a maximum permitted mass flow rate of the working fluid through the heat exchanger (for example, by balancing the hydronic system);
measuring the mass flow rate of the working fluid through the heat exchanger; and
adjusting the mass flow rate of the working fluid through the heat exchanger so that it is no greater than the maximum permitted mass flow rate.

In another embodiment of a method for operating a hydronic system as shown in FIG. 1A, the temperature measuring device 40 (a thermostat) measures the temperature of the zone air 34 in a particular zone 12 and compares it to a desired temperature for that zone. If the measured temperature is below the desired temperature, measuring device 40 signals fan 32 of VAV box 30 to turn on and heat the zone air 34. In response to this signal, the fan 32 signals the zone controller 52 that the fan is on and that heat is needed at the VAV box 30. In response to the signal from the fan 32 the zone controller 52 signals actuator 45 which opens valve 44. Note that in the previous method embodiment (system of FIG. 1), fan 32 was slaved to respond to signals from the master, zone controller 52. However, in this embodiment (system of FIG. 1A), zone controller 52 is slaved to the operation of fan 32, which can have processing capability, in the form of a microprocessor or programmable logic controller associated with it. Similar to the previously described method, valve 44 is in fluid communication with both heat exchanger 24 and the heat exchanger 26 associated with the zone 12, and permits working fluid 20 to flow to the heat exchanger 26, VAV box 30. In response to the signal from temperature measuring device 40, fan 32 forces zone air 34 though the heat exchanger 26 where heat is transferred from the working fluid 20 to the air 34 through conduction between the air and the coils 36 before it is discharged back into the zone 12. Fresh or “make-up” air 38 is also drawn from the ambient, forced through the heat exchanger 26 and into the zone 12. The zone controller 52 receives signals from the temperature measuring device 42, which measures the temperature difference of the working fluid 20 across the heat exchanger 26, i.e. the temperature difference between the working fluid 20 before heat is transferred between it and the zone air 34, and after heat is transferred between the working fluid 20 and the zone air 34. The zone controller 52 uses this information to adjust the mass flow rate of the working fluid 20 through the heat exchanger 26 by adjusting the valve 44 so as to maintain the temperature difference of the working fluid 20 across the heat exchanger constant. Maintaining this constant temperature difference allows the heat exchanger 24, which supplies heat to the working fluid 20, to operate more efficiently than if other parameters were used as a criterion for controlling the mass flow rate. As described above, the controller 52 again uses signals from the pressure measuring device 46 to adjust the valve 44 to limit the degree to which it may open so as not to exceed the maximum permitted mass flow rate established for the valve 44 during balancing of the system.

Hydronic systems according to the invention, and methods of operating such hydronic systems are expected to operate more efficiently and provide a comfortable environment with lower energy expenditure. They are expected to be less costly because they use half the number of valves as prior art systems and they are expected to be easier to balance.

What is claimed is:

1. A hydronic system for controlling the air temperature in at least one zone, said hydronic system comprising:
a working fluid for effecting heat transfer;
a first heat exchanger for imparting or removing heat to or from said working fluid;
a second heat exchanger for imparting or removing heat to or from air in said at least one zone, said second heat exchanger being in fluid communication with said first heat exchanger;
a valve controlling a mass flow rate of said working fluid through said second heat exchanger;
a pump in fluid communication with said first and second heat exchangers for pumping said working fluid therebetween;
a first temperature measuring device measuring said air temperature in said at least one zone;
a second temperature measuring device measuring a change in temperature of said working fluid across said second heat exchanger;
a controller in communication with said first and second temperature measuring devices and said valve; wherein
said controller controls said valve in response to signals from said second temperature measuring device indicative of said change in temperature of said working fluid across said second heat exchanger, and said controller controls said valve in response to signals from said first temperature measuring device indicative of said air temperature in said at least one zone.

2. The hydronic system according to claim 1, wherein said first heat exchanger comprises a boiler for adding heat to said working fluid.

3. The hydronic system according to claim 1, wherein said first heat exchanger comprises a chiller for removing heat from said working fluid.

4. The hydronic system according to claim 1, wherein said second heat exchanger further comprises a fan controlling a mass flow rate of said air through said second heat exchanger, said fan being in communication with said controller, said controller controlling said fan in response to signals from said first temperature measuring device indicative of said air temperature in said at least one zone.

5. The hydronic system according to claim 1, wherein said second heat exchanger further comprises a fan controlling a mass flow rate of said air through said second heat exchanger, said fan being in communication with said first temperature measuring device and said controller, said fan controlling said controller in response to signals from said first temperature measuring device indicative of said air temperature in said at least one zone, said controller controlling said valve.

6. The hydronic system according to claim 1, further comprising a pressure measuring device measuring a change in pressure of said working fluid across said valve, said controller being in communication with said pressure measuring device and controlling said valve so as to limit said mass flow rate of said working fluid through said second heat exchanger to a maximum value in response to signals from said pressure measuring device.

7. The hydronic system according to claim 1, further comprising:
an orifice in fluid communication with said second heat exchanger;
a pressure measuring device measuring a change in pressure of said working fluid across said orifice, said controller being in communication with said pressure measuring device and controlling said valve so as to limit said mass flow rate of said working fluid through said second heat exchanger to a maximum value in response to signals from said pressure measuring device.

8. The hydronic system according to claim 1, further comprising:
a venturi in fluid communication with said second heat exchanger;
a pressure measuring device measuring a change in pressure of said working fluid across said venturi, said controller being in communication with said pressure measuring device and controlling said valve so as to limit said mass flow rate of said working fluid through said second heat exchanger to a maximum value in response to signals from said pressure measuring device.

9. The hydronic system according to claim 1, further comprising a means for measuring a mass flow rate of said working fluid through said second heat exchanger, said controller being in communication with said means for measuring said mass flow rate and controlling said valve so as to limit said mass flow rate of said working fluid through said second heat exchanger to a maximum value in response to signals from said means for measuring said mass flow rate of said working fluid.

10. The hydronic system according to claim 9, wherein said means for measuring a mass flow rate of said working fluid through said second heat exchanger is selected from the group consisting of a hot wire anemometer, an orifice and a venturi.

11. The hydronic system according to claim 1, wherein said working fluid comprises water.

12. A hydronic system for controlling the air temperature in a plurality of zones, said hydronic system comprising:
a working fluid for effecting heat transfer;
a first heat exchanger for imparting or removing heat to or from said working fluid;
a plurality of first temperature measuring devices, at least one of said first temperature measuring devices measuring said air temperature in at least one of said zones;
a plurality of second heat exchangers, at least one of said second heat exchangers for imparting or removing heat to or from air in said at least one zone, said at least one second heat exchanger being in fluid communication with said first heat exchanger, said at least one second heat exchanger comprising:
a valve controlling a mass flow rate of said working fluid through said at least one second heat exchanger;
a second temperature measuring device measuring a change in temperature of said working fluid across said at least one second heat exchanger;
said hydronic system further comprising:
at least one pump in fluid communication with said first heat exchanger and said at least one second heat exchanger for pumping said working fluid therebetween;
a controller in communication with said at least one first temperature measuring device, said second temperature measuring device and said valve associated with said at least one second heat exchanger;
wherein for said at least one second heat exchanger in said at least one zone, said controller controlling said valve in response to signals from said first and second temperature measuring devices.

13. The hydronic system according to claim 12, wherein said first heat exchanger comprises a boiler for adding heat to said working fluid.

14. The hydronic system according to claim 12, wherein said first heat exchanger comprises a chiller for removing heat from said working fluid.

15. The hydronic system according to claim 12, wherein said at least one second heat exchanger further comprises a fan controlling a mass flow rate of said air through said at least one second heat exchanger, said fan being in communication with said controller, said controller controlling said fan in response to signals from said first temperature measuring device indicative of said air temperature in said at least one zone.

16. The hydronic system according to claim 12, wherein said at least one second heat exchanger further comprises a fan controlling a mass flow rate of said air through said at least one second heat exchanger, said fan being in communication with said at least one first temperature measuring device and said controller, said fan controlling said controller in response to signals from said at least one first temperature measuring device indicative of said air temperature in said at least one zone, said controller controlling said valve.

17. The hydronic system according to claim 12, wherein said at least one second heat exchanger further comprises a pressure measuring device measuring a change in pressure of said working fluid across said valve, said controller being in communication with said pressure measuring device and controlling said valve so as to limit said mass flow rate of said working fluid through said at least one second heat exchanger to a maximum value in response to signals from said pressure measuring device.

18. The hydronic system according to claim 12, further comprising:
an orifice in fluid communication with said at least one second heat exchanger;
a pressure measuring device measuring a change in pressure of said working fluid across said orifice, said controller being in communication with said pressure measuring device and controlling said valve so as to limit said mass flow rate of said working fluid through said at least one second heat exchanger to a maximum value in response to signals from said pressure measuring device.

19. The hydronic system according to claim 12, further comprising:
a venturi in fluid communication with said at least one second heat exchanger;
a pressure measuring device measuring a change in pressure of said working fluid across said venturi, said controller being in communication with said pressure measuring device and controlling said valve so as to limit said mass flow rate of said working fluid through said at least one second heat exchanger to a maximum value in response to signals from said pressure measuring device.

20. The hydronic system according to claim 12, further comprising a means for measuring a mass flow rate of said working fluid through said at least one second heat exchanger, said controller being in communication with said means for measuring said mass flow rate and controlling said valve so as to limit said mass flow rate of said working fluid through said at least one second heat exchanger to a maximum value in response to signals from said means for measuring said mass flow rate of said working fluid.

21. The hydronic system according to claim 20, wherein said means for measuring a mass flow rate of said working fluid through said at least one second heat exchanger is selected from the group consisting of a hot wire anemometer, an orifice and an venturi.

22. The hydronic system according to claim 12, wherein said working fluid comprises water.

23. A method of operating a hydronic system for controlling the air temperature in at least one zone, said method comprising:
moving a working fluid through a heat exchanger;
moving air from said at least one zone through said heat exchanger for transferring heat between said working fluid and said air;
measuring a first temperature of said working fluid before heat is transferred between said working fluid and said air;
measuring a second temperature of said working fluid after heat is transferred between said working fluid and said air;
adjusting a mass flow rate of said working fluid through said heat exchanger so as to maintain a constant temperature difference between said first and second temperatures of said working fluid;
measuring said air temperature in said at least one zone;
adjusting a mass flow rate of said air from said at least one zone through said heat exchanger so as to achieve and maintain a desired air temperature in said at least one zone.

24. The method according to claim 23, further comprising:
establishing a maximum permitted mass flow rate of said working fluid through said heat exchanger;
measuring said mass flow rate of said working fluid through said heat exchanger; and
adjusting said mass flow rate of said working fluid through said heat exchanger so that it is no greater than said maximum permitted mass flow rate.

25. The method according to claim 24, wherein establishing said maximum permitted mass flow rate of said working fluid through said heat exchanger comprises balancing a mass flow of said working fluid through said hydronic system so that said mass flow rate of said working fluid through said heat exchanger is sufficient to meet a maximum required heat load at all times during operation of said hydronic system.

26. The method according to claim 23, further comprising adjusting the mass flow rate of said working fluid through said heat exchanger so as to maintain a constant temperature difference of about 20° F. between said first and second temperatures of said working fluid.

27. The method according to claim 23, further comprising adjusting the mass flow rate of said working fluid through said heat exchanger so as to maintain a constant temperature difference of about 40° F. between said first and second temperatures of said working fluid.

28. The method according to claim 23, further comprising adjusting the mass flow rate of said working fluid through said heat exchanger so as to maintain a constant temperature difference from about 20° F. to about 60° F. between said first and second temperatures of said working fluid.

29. The method according to claim 23, further comprising adjusting the mass flow rate of said working fluid through said heat exchanger so as to maintain a constant temperature difference of about 10° F. between said first and second temperatures of said working fluid.

30. The method according to claim 23, further comprising adjusting the mass flow rate of said working fluid through said heat exchanger so as to maintain a constant temperature difference from about 10° F. to about 30° F. between said first and second temperatures of said working fluid.

31. A method of operating a hydronic system for controlling the air temperature in a plurality of zones, said method comprising:
moving a working fluid through a plurality of heat exchangers, each heat exchanger being associated with a respective one of said zones;
for each said zone, moving air from said zone through said heat exchanger associated therewith for transferring heat between said working fluid and said air in said zone;
for each said heat exchanger, measuring a first temperature of said working fluid before heat is transferred between said working fluid and said air;
for each said heat exchanger, measuring a second temperature of said working fluid after heat is transferred between said working fluid and said air;
for each said heat exchanger, adjusting the mass flow rate of said working fluid through said heat exchanger so as to maintain a constant temperature difference between said first and second temperatures of said working fluid;
for each said zone, measuring the air temperature in said zone;
for each said heat exchanger and each said zone, adjusting the mass flow rate of air from said zone through said heat exchanger associated therewith so as to achieve and maintain a desired air temperature in said zone.

32. The method according to claim 31, further comprising:
for each said heat exchanger, establishing a respective maximum permitted mass flow rate of said working fluid therethrough;
for each said heat exchanger, measuring said mass flow rate of said working fluid therethrough; and
for each said heat exchanger, adjusting said mass flow rate of said working fluid therethrough so that it is no greater than said respective maximum permitted mass flow rate.

33. The method according to claim 32, wherein establishing said respective maximum permitted mass flow rate of said working fluid through each said heat exchanger comprises balancing a mass flow of said working fluid through said hydronic system so that said mass flow rate of said working fluid through each said heat exchanger is sufficient to meet a maximum required heat load at all times during operation of said hydronic system.

34. The method according to claim 31, further comprising adjusting the mass flow rate of said working fluid through each said heat exchanger so as to maintain a constant temperature difference of about 20° F. between said first and second temperatures of said working fluid.

35. The method according to claim 31, further comprising adjusting the mass flow rate of said working fluid through each said heat exchanger so as to maintain a constant temperature difference of about 40° F. between said first and second temperatures of said working fluid.

36. The method according to claim 31, further comprising adjusting the mass flow rate of said working fluid through each said heat exchanger so as to maintain a constant temperature difference from about 20° F. to about 60° F. between said first and second temperatures of said working fluid.

37. The method according to claim 31, further comprising adjusting the mass flow rate of said working fluid through each said heat exchanger so as to maintain a constant temperature difference of about 10° F. between said first and second temperatures of said working fluid.

38. The method according to claim 31, further comprising adjusting the mass flow rate of said working fluid through each said heat exchanger so as to maintain a constant temperature difference from about 10° F. to about 30° F. between said first and second temperatures of said working fluid.
